(19) United States
(12) Patent Application Publication
(10) Pub. No.: US 2003/0080276 A1
(43) Pub. Date: May 1, 2003

(54) Solar blind detector using SiC photodiode and rugate filter

(76) Inventors: Dale M. Brown, Schenectady, NY (US); Kanin Chu, Nashua, NH (US); George Theodore Dalakos, Niskayuna, NY (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 09/682,858

(22) Filed: Oct. 25, 2001

(51) Int. Cl. G01J 1/20; G01C 21/02

(52) U.S. Cl. 250/203.1

(57) ABSTRACT

A detector includes a filter for substantially blocking photons having wavelengths greater than about 250 nm. A photodiode has a low dark current less than about 0.4 pA/cm². A current from the photodiode is proportional to a quantity of photons having wavelengths less than or equal to about 250 nm which pass through the filter and impinge the photodiode. A processor determines the quantity of photons impinging the photodiode as a function of the current. In a preferred embodiment, the photodiode is a SiC photodiode.

### BACKGROUND OF INVENTION

The present invention relates generally to solar blind detectors. It finds particular application in conjunction with missile detection and tracking and will be described with particular reference thereto. It will be appreciated, however, that the invention is also amenable to other like applications, e.g., fire detection.

Vehicles (e.g., aircraft) operating in hostile environments need a wide variety of increasingly sophisticated devices to assure their survival. In order to intercept missiles, for example, launched from either the ground or air, they must be detected as early as possible. Early detection allows evasive action and other counter measures to be taken, which greatly reduces the effectiveness of such missiles. Early warning systems that detect ultraviolet (UV) from a missile's plume typically incorporate solar blind UV filters. Conventional filters provide a sharp attenuation in a short spectrum period to give a black background for the event being viewed and eventually detected. The filters are employed to improve the performance of light detectors having unsuitable operating characteristics.

Typical, solar blind detectors are Geiger Muller gas filled thyratron tubes. Short wavelength UV photons (e.g., λ≦270 nm) strike a coated cathode which emits electrons. High voltage (e.g., V≧800 volts) between the cathode and anode of the tube accelerates the electrons, which causes the electrons to impact gas molecules. In this manner, the gas molecules are ionized. Once the gas molecules are ionized, a gas avalanche occurs and the voltage across the tube drops. The voltage drop represents a signal drop that indicates a detection of UV photons.

There are several drawbacks associated with the solar blind detectors currently used:

1) Because the tube is not a solid state device, a high voltage supply is required.

2) The process for making the cathode coating sensitive to UV is difficult to control.

3) The tube and its power supply are heavier, more expensive and less reliable than a solid state device. Furthermore, the high voltage line poses a safety and potential explosive danger. Therefore, such devices are not compatible with modern low voltage solid state electronics.

4) There has been an attempt (and much research done) for the purpose of replacing the solar blind Geiger Muller tube with AlGaN photodiodes. These photodiodes have not as yet been successful for a number of technical reasons, including:a)The amount of Al in the AlGaN starting material needs to be excessive (e.g., ≧40%). Material quality suffers at such a high level of Al.

b) AlGaN photodiodes have excessive dark current (e.g., ≧nA/cm²).

c) Because AlGaN photodiodes exhibit a long wavelength responsivity tail when the Al concentration approaches 40%, AlGaN photodiodes are not completely solar blind.

d) Good AlGaN photodiodes are not yet available because the yield is very low. The low yield is caused by crystal defects that occur during the epitaxial growth of AlGaN layers on sapphire or even SiC substrates.

e) Electron trapping effects make the recovery times of AlGaN photodiodes relatively long. Therefore, such photodiodes are not compatible with high speed detection systems.

f) An Si diode having a phosphor coating may be utilized if an appropriate filter is utilized. However, the most used filter is composed of organic films that are not reliable for temperatures ≧°C. and the dark current of an Si diode is considerably higher than that of SiC.

For the reasons stated above, attempts to utilize Geiger Muller tubes for solar blind applications (e.g., missile detection and tracking) have been very disappointing.

The present invention provides a new and improved apparatus and method which overcomes the above-referenced problems and others.

### SUMMARY OF INVENTION

A detector includes a filter for substantially blocking photons having wavelengths of greater than about 250 nm. A photodiode has a low dark current less than about 0.4 pA/cm². A current from the photodiode is proportional to a quantity of photons having wavelengths less than or equal to about 250 nm, which pass through the filter and impinge the photodiode. A processor determines the quantity of photons impinging the photodiode as a function of the current.

In accordance with one aspect of the invention, the photodiode has a bandgap of greater than or equal to about 2.7 eV.

In accordance with a more limited aspect of the invention, the photodiode is an SiC photodiode.

In accordance with another aspect of the invention, the filter provides a rise characterized as from less than about 50% reflectance to more than about 97% reflectance within a range of less than about 3 wavelengths. The filter also provides a cutoff characterized as from greater than about 99% reflectance to less than about 50% reflectance within a range of less than about 25 wavelengths.

In accordance with a more limited aspect of the invention, the filter is a Rugate filter. A multiple dielectric layer filter composed of alternate layers of silicon nitride (Si₃N₄) and silicon dioxide (SiO₂) or alternate layers of hafnium oxide (HfO₂) and SiO₂ could also be used.

In accordance with another aspect of the invention, the filter includes inorganic material not degraded by temperatures greater than or equal to about 175° C.

In accordance with a more limited aspect of the invention, the inorganic material includes SiO₂ and Si₃N₄ or SiO₂ and HfO₂.

In accordance with another aspect of the invention, the photons are included within a missile plume, or fire flame, such as occurs when gasoline burns or explodes.

In accordance with another aspect of the invention, a signal conditioner transforms the current from the photodiode into a signal transmitted to the processor. The processor determines the quantity of photons impinging the photodiode as a function of the signal.

In accordance with a more limited aspect of the invention, the current from the photodiode is analog and the signal transmitted to the processor is digital. The signal conditioner includes an amplifier for amplifying the analog current and an analog-to-digital converter for converting the analog current to the digital signal. Alternately, the signal conditioner is simply an amplifier which amplifies the analog current such that an alarm is triggered when a threshold level is exceeded.

One advantage of the present invention is that it incorporates SiC photodiodes, which are reliable for temperatures ≧175 ° C.

Another advantage of the present invention is that it provides a means for detecting a small number of photons having wavelengths ≦250 nm.

Another advantage of the present invention is that it provides a low noise detection system.

Still further advantages of the present invention will become apparent to those of ordinary skill in the art upon reading and understanding the following detailed description of the preferred embodiments.

### BRIEF DESCRIPTION OF DRAWINGS

The invention may take form in various components and arrangements of components, and in various steps and arrangements of steps. The drawings are only for purposes of illustrating a preferred embodiment and are not to be construed as limiting the invention.

FIG. 1 illustrates a the device of the present invention within a typical environment.

FIG. 2 illustrates the device of the present invention.

FIG. 3 illustrates a graph showing reflectance vs. wavelength for a Rugate filter according to the present invention.

FIG. 4 illustrates a graph showing current vs. voltage for a SiC photodiode according to the present invention.

### DETAILED DESCRIPTION

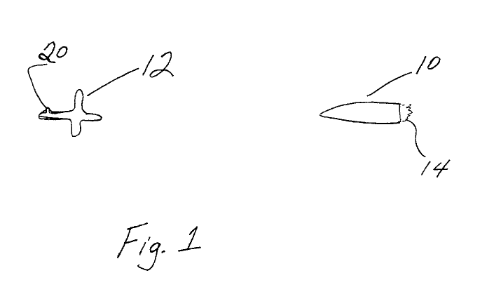

With reference to FIG. 1, an object 10 (e.g., a missile) is moving toward a target 12 (e.g., an airplane or other mobile or immobile target). A plume 14, which results from missile exhaust, trails behind the missile 10. Ultraviolet (UV) radiation, which is created by fire in the exhaust, is included in the plume 14. The plume 14 and the UV radiation are indicative of a current position of the missile 10. As described in more detail below, the current position of the object 10 is used for determining a distance and direction between the missile 10 and the target 12.

In general, UV radiation includes wavelengths which extend between a range of about 200 nm to about 400 nm. Solar radiation (i.e., UV radiation from the sun) includes wavelengths within the range of about 250 nm to more than 1 μm. The wavelengths of UV radiation included within the plume 14 is typically below about 250 nm (i.e., within a range of about 200 nm to about 220 nm).

A device 20 is used for detecting the UV radiation from the plume 14 or other combustion event of interest, e.g., a fire or explosion. Although the device 20 is illustrated in the preferred embodiment as secured to the target 12, it is to be understood that other embodiments, in which the device 20 is not attached to the target 12 (e.g., is on the ground), are also contemplated. If the plume 14 is set against a background including solar radiation (e.g., a sunlit sky), the device 20 distinguishes between solar UV radiation and UV radiation produced by the exhaust and/or emanating from the plume 14.

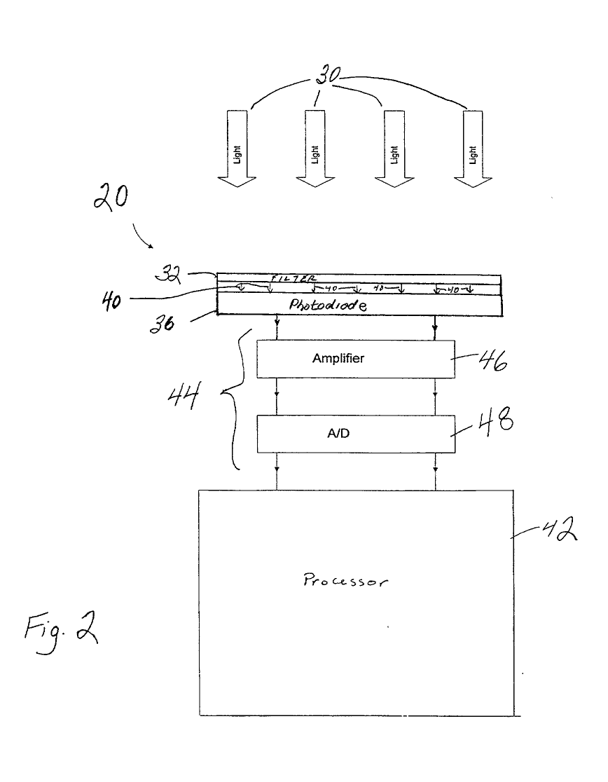

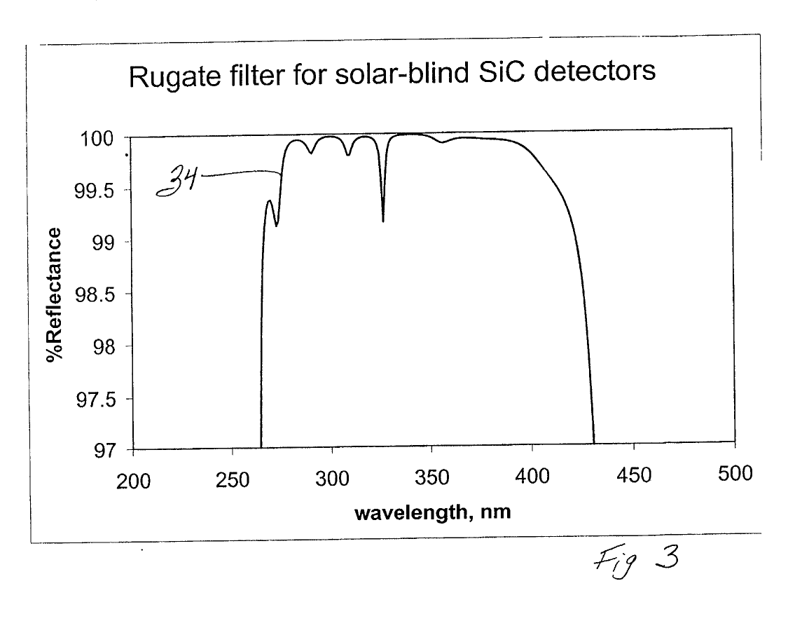

With reference to FIGS. 1 and 2, photons 30 (light), including UV radiation (both solar radiation and UV radiation from the missile exhaust) are incident on the device 20. The device 20 (detector) includes a filter 32 for substantially blocking photons with wavelengths greater than about 250 nm (e.g., about 270 nm), but permitting photons with wavelengths less than about 250 nm to pass. As the graph 34 illustrated in FIG. 3 shows, the filter 32 in the preferred embodiment provides a rise in reflectance at about the 270 nm wavelength mark. The rise is characterized as from less than about 50% reflectance to more than about 97% reflectance within a span of less than about 3 wavelengths. The filter 32 also provides a cutoff or fall in reflectance at about the 425 nm wavelength mark. The cutoff is characterized as from greater than about 99% reflectance to less than about 50% reflectance within a span of less than about 25 wavelengths. In the preferred embodiment, the filter 32 is a Rugate filter. However, it is to be understood that other filters are also contemplated. Furthermore, the filter 32 preferably includes inorganic materials (e.g., layers of SiO₂and Si₃N₄ or SiO₂ and HfO₂) not degraded by temperatures greater than or equal to about 175° C.

With reference again to FIGS. 1 and 2, a photodiode 36 is positioned to receive the photons 40 that pass through the filter 32. Preferably, the photodiode 36 is a SiC photodiode. It is to be noted that wavelengths greater than about 400 nm are not detected by the SiC photodiode. Accordingly, responses to solar radiation having wavelengths greater than 400 nm are substantially eliminated. Therefore, when the SiC photodiode is combined with the filter 32, only UV radiation having wavelengths less than about 250 nm are detected. It is presumed then that the detected radiation is emanating from the plume 14 or other combustion event of interest.

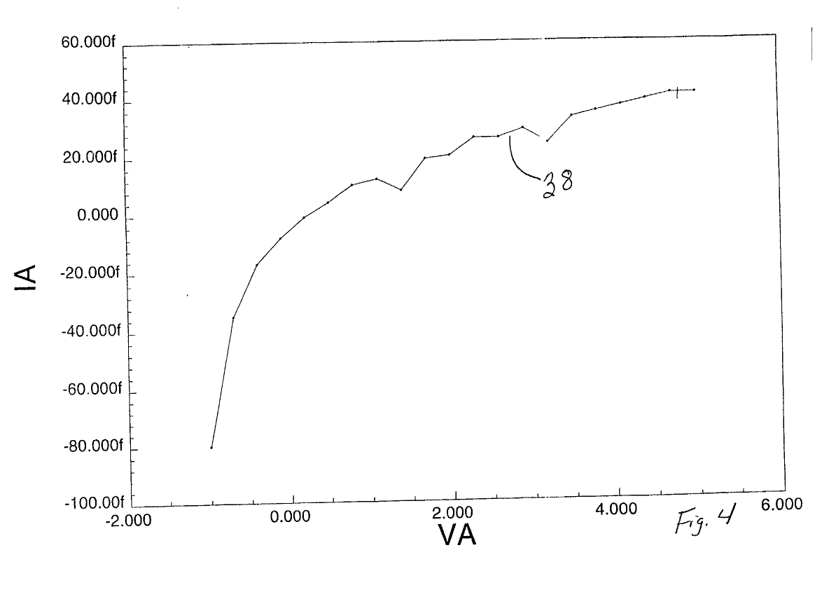

As shown in the graph 38 of FIG. 4, the photodiode 36 has a low dark current (e.g., less than about 0.4 pA/cm²) and a bandgap of greater than or equal to about 2.7 eV. With reference again to FIGS. 1 and 2, photons 40 that pass through the filter 32 impinge the photodiode 36. A current is produced within the photodiode 36 as a function of the impinging photons 40. More specifically, the current produced within the photodiode 36 is proportional to a quantity of the photons 40, which have wavelengths that are less than or equal to about 250 nm, that pass through the filter 32 and impinge the photodiode 36. A processor 42 determines the quantity of photons 40 impinging the photodiode 36 as a function of the current and determines if non-solar UV radiation (which is assumed to be from a missile plume) exists above a predetermined threshold. An operator of the target 12 is notified when the processor 42 determines non-solar UV radiation exists above the predetermined level. Optionally, the processor 42 determines a distance between the missile 10 and the target 12 as a function of the quantity of photons 40 impinging the photodiode 36.

The device 20 repeatedly determines the quantity of photons 40 impinging the photodiode 36 (and the distance between the missile 10 and the target 12) at predetermined time intervals. For example, the time interval may be set so that the processor 42 updates the quantity of photons 40 impinging the photodiode 36 in substantially real-time. The processor 42 maintains a historical database of the number of photons 40 impinging the photodiode 36 as a function of the relative positions of the missile 10 and the target 12. In this manner, the processor 42 tracks the closing distance between the object 10 and the target 12. Optionally, an intercepting missile (not shown) can be guided or steered to the missile 10 thereby destroying the missile 10 before it reaches the target 12.

In the preferred embodiment, current from the photodiode 36 represents an analog signal. A signal conditioner 44 transforms the current from the photodiode 36 into a digital signal, which is transmitted to the processor 42. More specifically, the signal conditioner 44 includes an amplifier 46 for amplifying the analog current and an analog-to-digital converter 48 for converting the analog current to the digital signal. The processor 42 then determines the of quantity of photons 40 impinging the photodiode 36 as a function of the digital signal.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

1. A detector, comprising:
a filter for substantially blocking photons having wavelengths of greater than about 250 nm;
a photodiode having a low dark current, a current from the photodiode being proportional to a quantity of photons having wavelengths of less than or equal to about 250 nm, which pass through the filter and impinge the photodiode; and,
a processor for determining the quantity of photons impinging the photodiode as a function of the current.

2. The detector as set forth in claim 1, wherein the photodiode has a bandgap of greater than or equal to about 2.7 eV.

3. The detector as set forth in claim 2, wherein the photodiode is an SiC photodiode.

4. The detector as set forth in claim 1, wherein:
the filter provides a rise characterized as from less than about 50% reflectance to more than about 97% reflectance within a range of less than about 3 wavelengths; and,
the filter provides a cutoff characterized as from greater than about 99% reflectance to less than about 50% reflectance within a range of less than about 25 wavelengths.

5. The detector as set forth in claim 4, wherein the filter is a Rugate filter.

6. The detector as set forth in claim 1, wherein the filter includes:
inorganic material not degraded by temperatures greater than or equal to about 175° C.

7. The detector as set forth in claim 6, wherein the inorganic material includes SiO₂ and Si₃N₄ or SiO₂ and HfO₂ or any other material pair with a discrete refractive index difference and being transparent in the wavelength region of interest.

8. The detector as set forth in claim 1, wherein the photons include photons from a combustion event.

9. The detector as set forth in claim 8, wherein the combustion event is a missile plume.

10. The detector as set forth in claim 1, further including:
a signal conditioner for transforming the current from the photodiode into a signal transmitted to the processor, the processor determining the quantity of photons impinging the photodiode as a function of the signal.

11. The detector as set forth in claim 10, wherein the current from the photodiode is analog and the signal transmitted to the processor is digital, the signal conditioner including:
an amplifier for amplifying the analog current; and,
an analog-to-digital converter for converting the analog current to the digital signal.

12. A method for detecting UV photons having wavelengths of less than about 250 nm, the method comprising:
filtering a plurality of UV photons to substantially block the UV photons having wavelengths greater than about 250 nm, the UV photons having wavelengths less than or equal to about 250 nm passing through the filter and impinging a photodiode which has a low dark current less than about 0.4 pA/cm²;
generating a current from the photodiode, the current being proportional to a quantity of photons impinging the photodiode; and,
determining the quantity of photons impinging the photodiode as a function of the current.

13. The method for detecting photons as set forth in claim 12, wherein the filtering step includes:
providing a rise characterized as from less than about 50% reflectance to more than about 97% reflectance within a range of less than about 3 wavelengths; and,
providing a cutoff characterized as from greater than about 99% reflectance to less than about 50% reflectance within a range of less than about 25 wavelengths.

14. The method for detecting photons as set forth in claim 12, wherein the current is an analog signal, further including:
transforming the analog current from the photodiode into a digital signal transmitted to a processor, the processor determining the of quantity of photons impinging the photodiode as a function of the digital signal.

15. The method for detecting photons as set forth in claim 14, wherein the transforming step includes:
amplifying the analog current; and,
converting the analog current to the digital signal.

16. The method for detecting photons as set forth in claim 12, further including:
detecting the plurality of photons that are included within a missile plume.

17. A system for detecting an object emitting ultraviolet radiation within an environment including solar ultraviolet photons, comprising:
a filter for substantially blocking solar ultraviolet photons;
an SiC photodiode, a current from the photodiode being proportional to a quantity of non-solar ultraviolet photons which pass through the filter and impinge the photodiode; and,
a processor for determining the quantity of the non-solar photons impinging the photodiode as a function of the current, determining whether the object is present as a function of the quantity of the non-solar photons.

18. The system for detecting an object as set forth in claim 17, wherein:
the filter provides a rise characterized as from less than about 50% reflectance to more than about 97% reflectance within a range of less than about 3 wavelengths; and,
the filter provides a cutoff characterized as from greater than about 99% reflectance to less than about 50% reflectance within a range of less than about 25 wavelengths.

19. The system for detecting an object as set forth in claim 18, wherein the filter includes:
inorganic material not degraded by temperatures greater than or equal to about 175° C.

20. The system for detecting an object set forth in claim 19, wherein the inorganic material includes SiO₂ and Si₃N₄ or SiO₂ and HfO₂ or any other material pair with a discrete refractive index difference and being transparent in the wavelength region of interest.

21. The system for detecting an object as set forth in claim 17, wherein the processor tracks respective quantities of the non-solar photons at respective positions of the object and determines respective distances between a target and the object as a function of the positions.
